(19) United States
(12) Patent Application Publication
(10) Pub. No.: US 2024/0206671 A1
(43) Pub. Date: Jun. 27, 2024

(54) Coffeemaker Apparatus

(71) Applicant: Chris Blessinger, Jasper, IN (US)

(72) Inventor: Chris Blessinger, Jasper, IN (US)

(21) Appl. No.: 18/087,300

(22) Filed: Dec. 22, 2022

(51) Int. Cl. A47J 31/46; A47J 31/44; A47J 31/52

(52) U.S. Cl. CPC A47J 31/467; A47J 31/446; A47J 31/461; A47J 31/468; A47J 31/469; A47J 31/5253; A47J 31/5255

(57) ABSTRACT

A coffeemaker apparatus for brewing, storing, and reheating coffee includes a coffeemaker which brews a batch of coffee into a tank, then dispenses individual servings of coffee on demand while reheating the coffee as it dispenses.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to coffeemaker apparatuses and more particularly pertains to a new coffeemaker apparatus for brewing, storing, and reheating coffee.

### (2) Description of Related Art Including Information Disclosed Under 37 CFR 1.97 and 1.98.

The prior art relates to coffeemaker apparatuses including at least one device which keeps water at an elevated temperature and brews a batch of coffee with the preheated water. The device then stores the batch of coffee at an unheated temperature and dispenses individual servings of the coffee, heating the coffee by exchanging heat with the preheated water. Numerous other devices include components for selecting a temperature of a dispensed amount of coffee, for cooling brewed coffee, and for dispensing a metered quantity of coffee. The prior art fails to address a coffeemaker apparatus which has structure for dispensing selectable sizes of coffee using a separate heating device.

### BRIEF SUMMARY OF THE INVENTION

An embodiment of the disclosure meets the needs presented above by generally comprising a housing having an outer wall, the outer wall defining an interior space. A supply tank is coupled to the housing and is positioned within the interior space at a rear side of the interior space. Water is contained in the supply tank. A brew tank is coupled to the housing and is positioned within the interior space at a front side of the interior space. The brew tank has a top wall and a hole extending through the top wall into the brew tank. A filter basket is removably engaged with the housing such that the filter basket is retained above the brew tank. The filter basket has a bowl with an open top and a bottom wall. The bowl has an orifice extending through the bottom wall. Coffee grounds are contained in the filter basket.

A supply pipe is fluidly coupled to the supply tank. The supply pipe extends from a bottom end of the supply tank upwardly and terminates in a discharge end positioned above the filter basket. The discharge end is open. A supply heater is coupled to the supply pipe for selectively heating the water flowing through the supply pipe from the supply tank. The supply heater includes pumping means for urging the water through the supply pipe away from supply tank. Water urged through the discharge end of the supply pipe infuses with the coffee grounds to define a brewed coffee which dispenses into the brew tank.

A dispenser pipe is fluidly coupled to the brew tank. The dispenser pipe extends from a bottom side of the brew tank and terminates in a dispensing end. The dispensing end is positioned forwardly of the brew tank and faces downwardly. The dispensing end is open. A dispenser pump is coupled to the dispenser pipe for selectively urging the brewed coffee from the brew tank through the dispenser pipe to the dispensing end, and a dispenser heater is coupled to the dispenser pipe for selectively heating the brewed coffee flowing through the dispenser pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a coffeemaker apparatus according to an embodiment of the disclosure.

FIG. 2 is a front view of an embodiment of the disclosure.

FIG. 3 is a rear bottom side perspective view of an embodiment of the disclosure without the housing.

FIG. 4 is a cross-section view of an embodiment of the disclosure taken from the direction of Arrows 4-4 in FIG. 2.

FIG. 5 is a cross-section view of an embodiment of the disclosure taken from the direction of Arrows 5-5 in FIG. 2.

FIG. 6 is a top front side perspective view of an embodiment of the disclosure without the housing.

FIG. 7 is an in-use view of an embodiment of the disclosure.

### DETAILED DESCRIPTION OF THE INVENTION

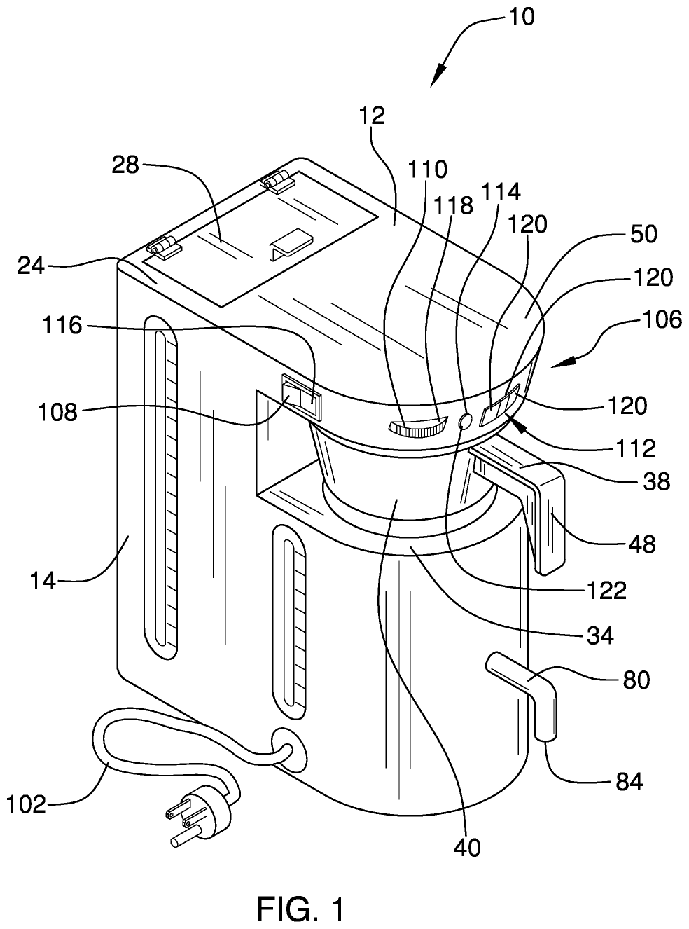

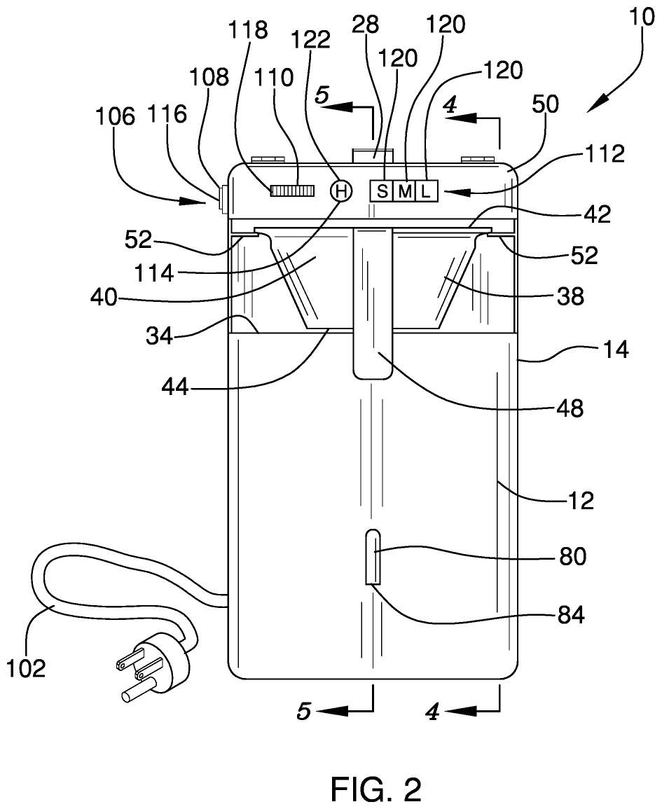

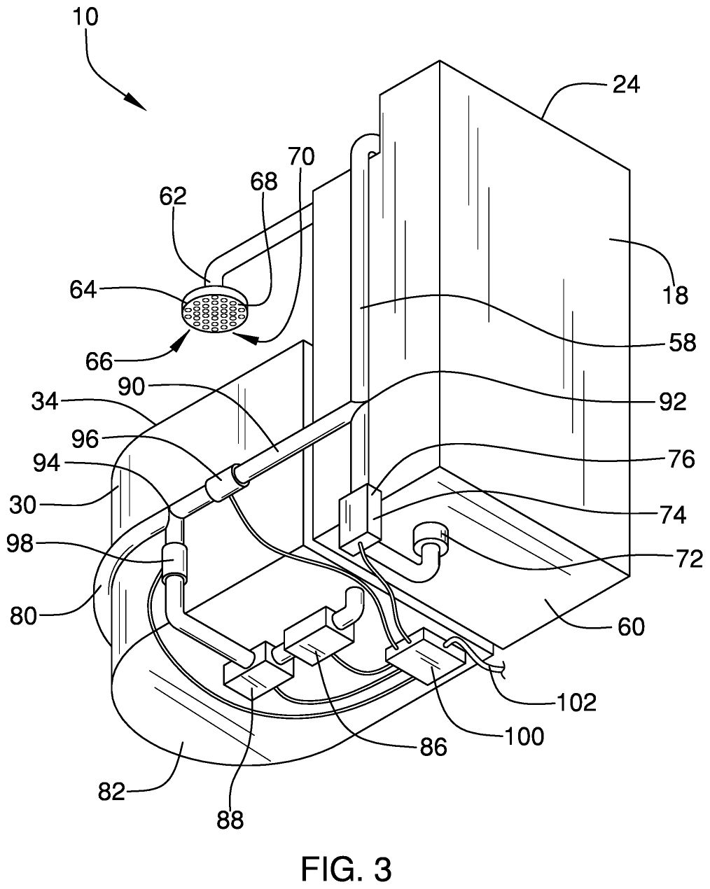

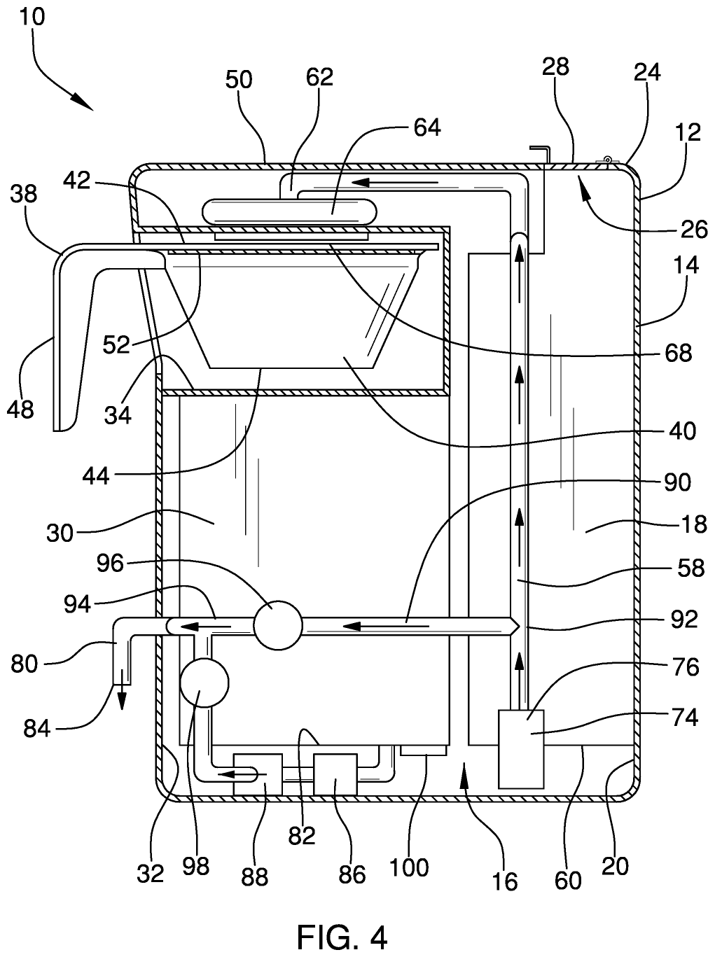

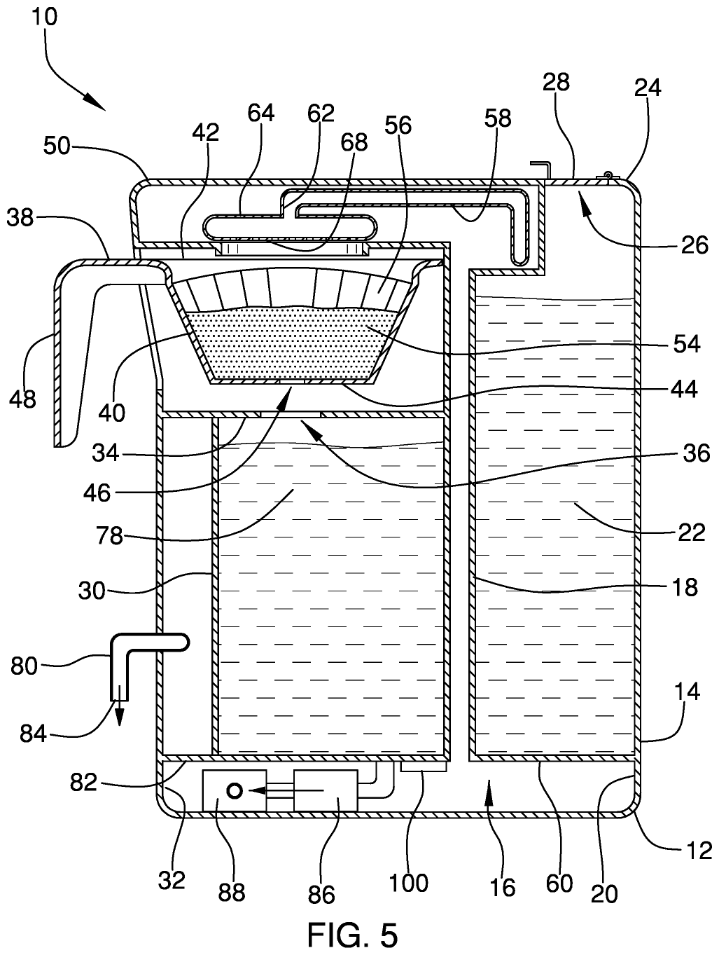

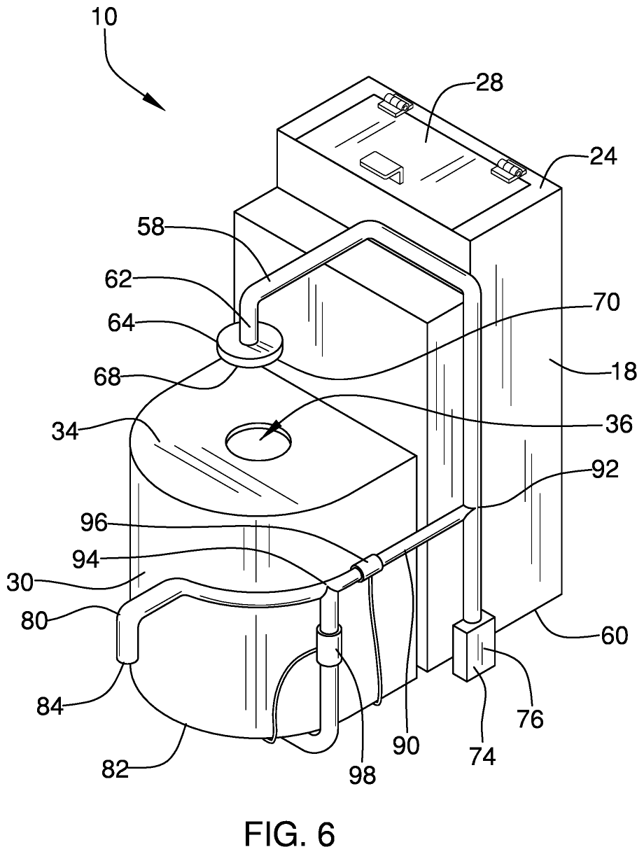

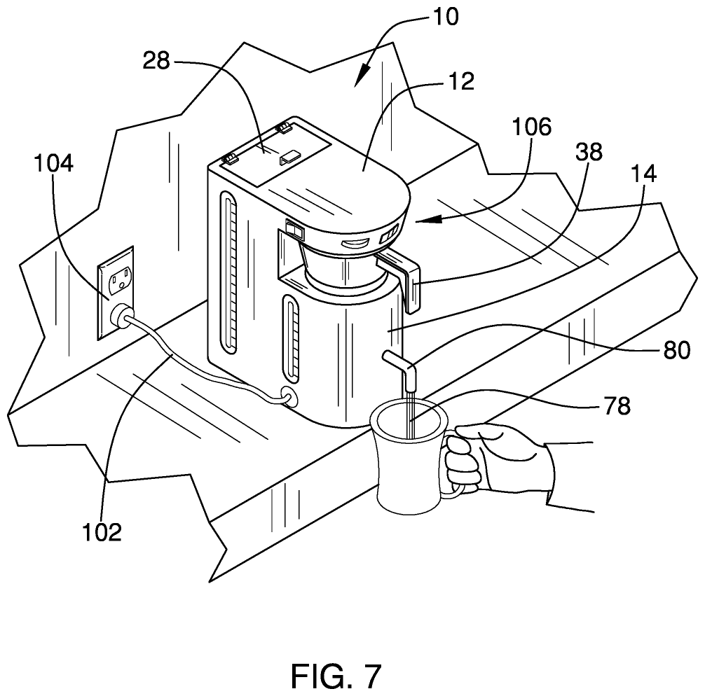

With reference now to the drawings, and in particular to FIGS. 1 through 7 thereof, a new coffeemaker apparatus embodying the principles and concepts of an embodiment of the disclosure and generally designated by the reference numeral 10 will be described.

As best illustrated in FIGS. 1 through 7, the coffeemaker apparatus 10 generally comprises a housing 12 comprising an outer wall 14, the outer wall 14 defining an interior space 16. A supply tank 18 is coupled to the housing 12 and is positioned within the interior space 16 at a rear side 20 of the interior space 16. Water 22 is contained in the supply tank 18. The supply tank 18 has an upper wall 24 and an opening 26 extending through the upper wall 24 into the supply tank 18. The upper wall 24 is integrated with the housing 12. A lid 28 is pivotally coupled to the upper wall 24 of the supply tank 18 to cover the opening 26 of the supply tank 18. The lid 28 may also be slidably coupled to the upper wall 24, detachable from the upper wall 24, or the like.

A brew tank 30 is coupled to the housing 12 and is positioned within the interior space 16 at a front side 32 of the interior space 16. The brew tank 30 has a top wall 34 and a hole 36 extending through the top wall 34 into the brew tank 30. The top wall 34 is integrated with the housing 12. The brew tank 30 is fixed relative to the supply tank 18.

A filter basket 38 is removably engaged with the housing 12 such that the filter basket 38 is retained above the brew tank 30. The filter basket 38 has a bowl 40 with an open top 42 and a bottom wall 44, and an orifice 46 extends through the bottom wall 44. The filter basket 38 also has a handle 48 extending outwardly from the bowl 40. The housing 12 has an overhang portion 50 which is spaced above the brew tank 30 and a pair of ledges 52 extending downwardly from the overhang portion 50 and inwardly to engage the bowl 40 to retain the filter basket 38 above the brew tank 30. Alternatively, the filter basket 38 may alternatively be supported by the brew tank 30, the housing 12 below the filter basket 38, or the like. Coffee grounds 54 are contained in the filter basket 38. The filter basket 38 may have a mesh screen or like filter for retaining the coffee grounds 54 in the filter basket 38, or a separate coffee filter 56 may be used.

A supply pipe 58 is fluidly coupled to the supply tank 18. The supply pipe 58 extends from a bottom end 60 of the supply tank 18 upwardly and terminates in a discharge end 62 positioned above the filter basket 38. The discharge end 62 is open. A nozzle 64 is coupled to the discharge end 62 of the supply pipe 58 which has a plurality of apertures 66 extending into a bottom surface 68 of the nozzle 64. The plurality of apertures 66 is arranged across an area 70 which may have a circular shape. The water 22 is dispensed downwardly through the nozzle 64 across the area 70 to evenly soak the coffee grounds 54 in the water 22.

A one-way valve 72 is coupled to the supply pipe 58 adjacent to the supply tank 18 to permit the water 22 to flow only out of the supply tank 18. A supply heater 74 is coupled to the supply pipe 58 for selectively heating the water 22 flowing through the supply pipe 58 from the supply tank 18. The supply heater 74 is positioned lower than the discharge end 62 of the supply pipe 58 and defines a bubble pump 76 for urging the water 22 upwardly through the supply pipe 58 away from the supply tank 18 while simultaneously heating the water 22. Alternative pumping means may be used such as a positive-displacement pump, a centrifugal pump, or the like. Water 22 urged through the discharge end 62 of the supply pipe 58 infuses with the coffee grounds 54 to define a brewed coffee 78 which dispenses into the brew tank 30.

A dispenser pipe 80 is fluidly coupled to the brew tank 30. The dispenser pipe 80 extends from a bottom side 82 of the brew tank 30 and terminates in a dispensing end 84 which is positioned forwardly of the brew tank 30 and faces downwardly. The dispensing end 84 is open. The dispenser pipe 80 is formed adjacent to the dispensing end 84 to extend forwardly from the brew tank 30 through the housing 12 and to curve downwardly outside of the housing 12. A dispenser pump 86 is coupled to the dispenser pipe 80 for selectively urging the brewed coffee 78 from the brew tank 30 through the dispenser pipe 80 to the dispensing end 84. A dispenser heater 88 is coupled to the dispenser pipe 80 for selectively heating the brewed coffee 78 flowing through the dispenser pipe 80.

A hot water pipe 90 is fluidly coupled to the supply pipe 58 at a first junction 92 and the dispenser pipe 80 at a second junction 94 for facilitating transmission of the water 22 from the supply tank 18 to the dispensing end 84 of the dispenser pipe 80. The first junction 92 is positioned between the supply heater 74 and the discharge end 62 of the supply pipe 58, and the second junction 94 is positioned between the dispenser heater 88 and the dispensing end 84 of the dispenser pipe 80. A hot water valve 96 is coupled to the hot water pipe 90. The hot water valve 96 is selectively closable to prevent transmission of the water 22 and the brewed coffee 78 through the hot water pipe 90 and selectively openable to permit transmission of the water 22 urged by the bubble pump 76 to the dispenser pipe 80.

A hot coffee valve 98 is coupled to the dispenser pipe 80 between the brew tank 30 and the second junction 94 and adjacent to the second junction 94. The hot coffee valve 98 is selectively closable to prevent transmission of the water 22 into the dispenser pipe 80 between the second junction 94 and the brew tank 30 and selectively openable to permit transmission of the brewed coffee 78 urged by the dispenser pump 86 to the dispenser end of the dispenser pipe 80.

A control circuit 100 is positioned within the housing 12 and is electrically coupled to the supply heater 74, the dispenser pump 86, the dispenser heater 88, the hot water valve 96, and the hot coffee valve 98. An electrical wire 102 is electrically coupled to the control circuit 100. The electrical wire 102 extends laterally through the housing 12 and is configured for electrically coupling to a power supply 104. An input 106 is electrically coupled to the control circuit 100 and comprises a brew actuator 108, a temperature setting actuator 110, a dispenser actuator 112, and a hot water actuator 114.

The brew actuator 108 is programmed for activating the supply heater 74 and activating the hot water valve 96 to close. The brew actuator 108 comprises a switch 116 positioned on the overhang portion 50 of the housing 12.

The temperature setting actuator 110 is programmed for selecting a temperature of a volume of the brewed coffee 78 to be dispensed through the dispenser end of the dispenser pipe 80. The temperature setting actuator 110 selectively adjusts at least one of a heat rate of the dispenser heater 88 and a flow rate of the dispenser pump 86 to set the temperature. The temperature setting actuator 110 comprises a dial 118 positioned on the overhang portion 50 of the housing 12. The dispenser actuator 112 is programmed for selecting a size of the volume of the brewed coffee 78 to be dispensed and dispensing the volume through the dispenser end of the dispenser pipe 80. The dispenser actuator 112 activates the dispenser pump 86, the dispenser heater 88, the hot coffee valve 98 to open, and the hot water valve 96 to close. The dispenser actuator 112 comprises a plurality of size buttons 120 positioned on the overhang portion 50 of the housing 12, and each size button 120 corresponds to one of a plurality of cup sizes.

The hot water actuator 114 is programmed for dispensing heated water 22 through the dispenser end of the dispenser pipe 80. The hot water actuator 114 activates the supply heater 74 and activates the hot water valve 96 to open. The hot water actuator 114 comprises a hot water button 122 positioned on the overhang portion 50 of the housing 12.

In use, the coffeemaker apparatus 10 brews coffee when the brew actuator 108 is actuated and operates as described above to heat water 22 coming from the supply tank 18 and urge it out of the discharge end 62 of the supply pipe 58 to infuse with the coffee grounds 54. Brewed coffee 78 is deposited through the hole 36 of the top wall 34 of the brew tank 30 and into the brew tank 30. To dispense the brewed coffee 78, the temperature setting actuator 110 is actuated to select the temperature of the volume of the brewed coffee 78 to be dispensed, and the dispenser actuator 112 is actuated to dispense the volume of the brewed coffee 78 in a cup size corresponding to a selected one of the plurality of size buttons 120. To dispense only hot water 22, the hot water actuator 114 is actuated to heat the water 22 from the supply tank 18 and urge it to the dispensing end 84 of the dispenser pipe 80.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A coffeemaker apparatus for making, reheating, and dispensing coffee, said apparatus comprising:
a housing comprising an outer wall, said outer wall defining an interior space;
a supply tank being coupled to said housing and being positioned within said interior space, said supply tank being positioned at a rear side of said interior space;
a water being contained in said supply tank;
a brew tank being coupled to said housing and being positioned within said interior space, said brew tank being positioned at a front side of said interior space, said brew tank having a top wall and a hole extending through said top wall into said brew tank;
a filter basket being removably engaged with said housing such that said filter basket is retained above said brew tank, said filter basket having a bowl with an open top and a bottom wall, said bowl having an orifice extending through said bottom wall;
a coffee grounds being contained in said filter basket;
a supply pipe being fluidly coupled to said supply tank, said supply pipe extending from a bottom end of said supply tank upwardly and terminating in a discharge end positioned above said filter basket, said discharge end being open;
a supply heater being coupled to said supply pipe for selectively heating said water flowing through said supply pipe from said supply tank, said supply heater including pumping means for urging said water through said supply pipe away from supply tank, whereby said water urged through said discharge end of said supply pipe infuses with said coffee grounds to define a brewed coffee which dispenses into said brew tank;
a dispenser pipe being fluidly coupled to said brew tank, said dispenser pipe extending from a bottom side of said brew tank and terminating in a dispensing end, said dispensing end being positioned forwardly of said brew tank and facing downwardly, said dispensing end being open;
a dispenser pump being coupled to said dispenser pipe for selectively urging said brewed coffee from said brew tank through said dispenser pipe to said dispensing end; and
a dispenser heater being coupled to said dispenser pipe for selectively heating said brewed coffee flowing through said dispenser pipe.

2. The apparatus of claim 1, wherein said supply tank having an upper wall and an opening extending through said upper wall into said supply tank, said upper wall being integrated with said housing, said top wall of said brew tank being integrated with said housing.

3. The apparatus of claim 2, further comprising a lid being positionable to cover said opening of said supply tank, said lid being pivotally coupled to said upper wall of said supply tank.

4. The apparatus of claim 1, wherein said brew tank is fixed relative to said supply tank.

5. The apparatus of claim 1, wherein said filter basket has a handle extending outwardly from said bowl.

6. The apparatus of claim 1, wherein said housing has an overhang portion being spaced above said brew tank and a pair of ledges extending downwardly from said overhang portion and inwardly to engage said bowl to retain said filter basket above said brew tank.

7. The apparatus of claim 1, further comprising a nozzle being coupled to said discharge end of said supply pipe, said nozzle having a plurality of apertures extending into a bottom surface of said nozzle, said plurality of apertures being arranged across an area, wherein said water is dispensed downwardly through said nozzle across said area.

8. The apparatus of claim 7, wherein said area has a circular shape.

9. The apparatus of claim 1, further comprising a one-way valve being coupled to said supply pipe adjacent to said supply tank, said supply valve being configured to permit said water to flow only out of said supply tank, said supply heater being positioned lower than said discharge end of said supply pipe, said pumping means of said supply heater being a bubble pump defined by said supply heater, said bubble pump urging said water upwardly through said supply pipe away from said supply tank while simultaneously heating said water.

10. The apparatus of claim 1, wherein said dispenser pipe is formed adjacent to said dispensing end to extend forwardly from said brew tank through said housing and to curve downwardly outside of said housing.

11. The apparatus of claim 1, further comprising:
a hot water pipe being fluidly coupled to said supply pipe at a first junction and said dispenser pipe at a second junction for facilitating transmission of said water from said supply tank to said dispensing end of said dispenser pipe, said first junction being positioned between said supply heater and said discharge end of said supply pipe; and
a hot water valve being coupled to said hot water pipe, said hot water valve being selectively closable to prevent transmission of said water and said brewed coffee through said hot water pipe, said hot water valve being selectively openable to permit transmission of said water urged by said bubble pump to said dispenser pipe.

12. The apparatus of claim 11, wherein said second junction is positioned between said dispenser heater and said dispensing end of said dispenser pipe.

13. The apparatus of claim 11, further comprising a hot coffee valve being coupled to said dispenser pipe between said brew tank and said second junction, said hot coffee valve being positioned adjacent to said second junction, said hot coffee valve being selectively closable to prevent transmission of said water into said dispenser pipe between said second junction and said brew tank, said hot coffee valve being selectively openable to permit transmission of said brewed coffee urged by said dispenser pump to said dispenser end of said dispenser pipe.

14. The apparatus of claim 13, further comprising a control circuit being electrically coupled to said supply heater, said dispenser pump, said dispenser heater, said hot water valve, and said hot coffee valve, said control circuit being positioned within said housing.

15. The apparatus of claim 14, further comprising an input being electrically coupled to said control circuit, said input comprising:
a brew actuator for activating said supply heater, said brew actuator activating said hot water valve to close;
a dispenser actuator for selecting a size of a volume of said brewed coffee to be dispensed and dispensing said volume through said dispenser end of said dispenser pipe, said dispenser actuator activating said dispenser pump and said dispenser heater, said dispenser actuator activating said hot coffee valve to open and activating said hot water valve to close; and
a hot water actuator for dispensing heated water through said dispenser end of said dispenser pipe, said hot water actuator activating said supply heater, said hot water actuator activating said hot water valve to open.

16. The apparatus of claim 15, further comprising a temperature setting actuator for selecting a temperature of said volume of said brewed coffee to be dispensed through said dispenser end of said dispenser pipe, said temperature setting actuator selectively adjusting at least one of a heat rate of said dispenser heater and a flow rate of said dispenser pump to set said temperature.

17. The apparatus of claim 15, wherein said brew actuator comprises a switch being positioned on said overhang portion of said housing, said dispenser actuator comprising a plurality of size buttons being positioned on said overhang portion of said housing, each size button corresponding to one of a plurality of cup sizes, said hot water actuator comprising a hot water button being positioned on said overhang portion of said housing.

18. The apparatus of claim 16, wherein said temperature setting actuator comprises a dial being positioned on said overhang portion of said housing.

19. The apparatus of claim 14, further comprising an electrical wire being electrically coupled to said control circuit, said electrical wire extending laterally through said housing, said electrical wire being configured for electrically coupling to a power supply.

20. A coffeemaker apparatus for making, reheating, and dispensing coffee, said apparatus comprising:
a housing comprising an outer wall, said outer wall defining an interior space;
a supply tank being coupled to said housing and being positioned within said interior space, said supply tank being positioned at a rear side of said interior space, said supply tank having an upper wall and an opening extending through said upper wall into said supply tank, said upper wall being integrated with said housing;
a lid being positionable to cover said opening of said supply tank, said lid being pivotally coupled to said upper wall of said supply tank;
a water being contained in said supply tank;
a brew tank being coupled to said housing and being positioned within said interior space, said brew tank being positioned at a front side of said interior space, said brew tank having a top wall and a hole extending through said top wall into said brew tank, said top wall being integrated with said housing, said brew tank being fixed relative to said supply tank;
a filter basket being removably engaged with said housing such that said filter basket is retained above said brew tank, said filter basket having a bowl with an open top and a bottom wall, said bowl having an orifice extending through said bottom wall, said filter basket having a handle extending outwardly from said bowl, said housing having an overhang portion being spaced above said brew tank and a pair of ledges extending downwardly from said overhang portion and inwardly to engage said bowl to retain said filter basket above said brew tank;
a coffee grounds being contained in said filter basket;
a supply pipe being fluidly coupled to said supply tank, said supply pipe extending from a bottom end of said supply tank upwardly and terminating in a discharge end positioned above said filter basket, said discharge end being open;
a nozzle being coupled to said discharge end of said supply pipe, said nozzle having a plurality of apertures extending into a bottom surface of said nozzle, said plurality of apertures being arranged across an area, said area having a circular shape, wherein said water is dispensed downwardly through said nozzle across said area;
a one-way valve being coupled to said supply pipe adjacent to said supply tank, said supply valve being configured to permit said water to flow only out of said supply tank;
a supply heater being coupled to said supply pipe for selectively heating said water flowing through said supply pipe from said supply tank, said supply heater being positioned lower than said discharge end of said supply pipe, said supply heater defining a bubble pump for urging said water upwardly through said supply pipe away from said supply tank while simultaneously heating said water, whereby said water urged through said discharge end of said supply pipe infuses with said coffee grounds to define a brewed coffee which dispenses into said brew tank;
a dispenser pipe being fluidly coupled to said brew tank, said dispenser pipe extending from a bottom side of said brew tank and terminating in a dispensing end, said dispensing end being positioned forwardly of said brew tank and facing downwardly, said dispensing end being open, said dispenser pipe being formed adjacent to said dispensing end to extend forwardly from said brew tank through said housing and to curve downwardly outside of said housing;
a dispenser pump being coupled to said dispenser pipe for selectively urging said brewed coffee from said brew tank through said dispenser pipe to said dispensing end;
a dispenser heater being coupled to said dispenser pipe for selectively heating said brewed coffee flowing through said dispenser pipe;
a hot water pipe being fluidly coupled to said supply pipe at a first junction and said dispenser pipe at a second junction for facilitating transmission of said water from said supply tank to said dispensing end of said dispenser pipe, said first junction being positioned between said supply heater and said discharge end of said supply pipe, said second junction being positioned between said dispenser heater and said dispensing end of said dispenser pipe;
a hot water valve being coupled to said hot water pipe, said hot water valve being selectively closable to prevent transmission of said water and said brewed coffee through said hot water pipe, said hot water valve being selectively openable to permit transmission of said water urged by said bubble pump to said dispenser pipe;
a hot coffee valve being coupled to said dispenser pipe between said brew tank and said second junction, said hot coffee valve being positioned adjacent to said second junction, said hot coffee valve being selectively closable to prevent transmission of said water into said dispenser pipe between said second junction and said brew tank, said hot coffee valve being selectively openable to permit transmission of said brewed coffee urged by said dispenser pump to said dispenser end of said dispenser pipe;
a control circuit being electrically coupled to said supply heater, said dispenser pump, said dispenser heater, said hot water valve, and said hot coffee valve, said control circuit being positioned within said housing;
an input being electrically coupled to said control circuit, said input comprising:
a brew actuator for activating said supply heater, said brew actuator activating said hot water valve to close, said brew actuator comprising a switch being positioned on said overhang portion of said housing;
a temperature setting actuator for selecting a temperature of a volume of said brewed coffee to be dispensed through said dispenser end of said dispenser pipe, said temperature setting actuator selectively adjusting at least one of a heat rate of said dispenser heater and a flow rate of said dispenser pump to set said temperature, said temperature setting actuator comprising a dial being positioned on said overhang portion of said housing;
a dispenser actuator for selecting a size of said volume of said brewed coffee to be dispensed and dispensing said volume through said dispenser end of said dispenser pipe, said dispenser actuator activating said dispenser pump and said dispenser heater, said dispenser actuator activating said hot coffee valve to open and activating said hot water valve to close, said dispenser actuator comprising a plurality of size buttons being positioned on said overhang portion of said housing, each size button corresponding to one of a plurality of cup sizes; and
a hot water actuator for dispensing heated water through said dispenser end of said dispenser pipe, said hot water actuator activating said supply heater, said hot water actuator activating said hot water valve to open, said hot water actuator comprising a hot water button being positioned on said overhang portion of said housing; and
an electrical wire being electrically coupled to said control circuit, said electrical wire extending laterally through said housing, said electrical wire being configured for electrically coupling to a power supply.
